(19) United States
(12) Patent Application Publication
(10) Pub. No.: US 2003/0233245 A1
(43) Pub. Date: Dec. 18, 2003

(54) System safety analysis process and instruction

(76) Inventor: Michael G. Zemore, Fredericksburg, VA (US)

Correspondence Address: Naval Surface Warfare Center, Office of Counsel ( Patents) (Code XDC1), 17320 Dahlgren Road, Dahlgren, VA, 22448-5100, US

(21) Appl. No.: 10/172,229

(22) Filed: Jun. 17, 2002

(51) Int. Cl. G06F 17/60

(52) U.S. Cl. 705/1

(57) ABSTRACT

A safety analysis process and system are disclosed. The safety analysis evolution includes four phases: safety program definition, detailed safety analysis, safety disposition, and sustained safety engineering. In the safety program definition phase, a safety program is thoroughly defined through the generation of system safety plans and the establishment of the safety team. In the detailed safety analysis phase, the system is thoroughly analyzed using a systematic analysis approach while all engineering data is captured in the unified hazard tracking database. In the safety disposition phase, the safety posture is formally disclosed to safety review officials and operational safety precepts are generated. In the sustained safety engineering phase, the safety efforts are maintained, including maintaining the hazard tracking database and assessing the safety impact of reported problems, proposed engineering changes, maintenance changes, and incident reports.

### FIELD OF THE INVENTION

This invention relates to system safety analysis process, and more specifically to a methodical approach that describes the details of the sequence, scope, timeline and analysis instruction for all aspects of a well designed and thorough system safety analysis program.

### BACKGROUND OF THE INVENTION

In many different contexts, safety is important. This is especially true in the case of military applications, such as naval surface weapon applications. If safety analysis is not conducted, the equipment may become damaged, the environment damaged, or, worse, personnel may become injured or killed. There are many methods for conducting safety analyses. Many of these current safety analysis approaches are piecemeal in nature, and do not take into account the wide range of factors necessary to ensure life cycle and full operational safety. As a result, they are less than desirable, and can result in lapses in safety in the handling of weapons, ordnance, and so on. For these and other reasons, therefore, there is a need for the present invention.

### SUMMARY OF THE INVENTION

The invention relates to a system safety analysis process that can be utilized by system safety engineers when developing and executing system safety programs. This invention includes the process known as the Integrated Interoperable Safety Analysis Process (IISAP). This process takes into account the hardware, software, and operational functions of the system under review. The safety analysis process captures four phases: safety program definition, detailed safety analysis, safety disposition, and sustained safety engineering.

In the safety program definition, establishment of a well-organized and coordinated safety program is emphasized. A system safety management plan and a system safety program plan are written for this purpose. The combination of these plans establishes the System Safety Working Group, a key function for the execution of the safety program. The SSWG actively participates throughout the life of the safety program and ensures technical accuracy and thoroughness of analysis activities. In the detailed safety analysis phase, the safety program is fully engaged and detailed analysis activities are performed. The safety analyses focus on the proposed design of the system while providing alternative design concepts and materials to eliminate or mitigate identified hazards. The safety analyses leverage off the system safety critical events and system safety critical functions, defined during the detailed design analysis called the Preliminary Hazard Analysis (PHA).

The PHA and subsequent analyses captured within this phase of the process thoroughly define analysis activities and best practices to identify all safety related concerns associated with the hardware, software, human-computer system, subsystems, subsystem interactions, and external interface design. To capture the system safety engineering activities and analysis results a system hazard tracking database is established. Engineering data within the database is uniquely captured and systematically arranged such that it can be used to communicate various levels of detail from engineering design to qualitative evaluation. The database is established during the PHA and leverages off the previously defined preliminary hazards list.

The hazard tracking database is maintained throughout the life of the safety program and serves as the repository for all system safety engineering data and analysis results. This database system is unlike existing hazard databases since it includes a software hazard tracking element in addition to a combat system element. These unified elements ensure hazard analysis integration from the subsystem to the combat system and from software function to combat system function. The database structure allows records that correspond to defined system safety critical events and potential causes.

In the safety disposition phase, the safety program defines operational safety precepts and safety assessment reports resulting from analysis findings. Reports are easily created from the engineering data extracted from the system hazard tracking database since it is maintained during this phase and throughout the process. The safety assessment data and analysis results are presented before the various safety review boards including the Software System Safety Technical Review Panel (SSSTRP) and the Weapon System Explosive Safety Review Board (WSESRB).

Finally, in the sustained safety engineering phase, the safety program is continued by assessing the safety impact of new software or hardware trouble reports, engineering change proposals, interface change requests, maintenance requirement changes, operating procedures changes, training procedure changes, and accident/incident reports. The system hazard tracking database must be maintained with any change in risk reported. Disposal of antiquated equipment must follow the guidelines as set forth in the Programmatic Environmental Safety & Health Evaluation (PESHE) document and equipment refresh plans assessed for safety significance.

The invention thus defines a thorough, efficient, cost-effective, technically effective, consistent, systematic, and maintainable safety analysis process. The process enables integration of hardware and software safety analysis with system safety efforts and then to the combat system safety level. The process is developed for naval surface weapon systems but can be utilized in applications such as naval air systems and Marine Corps systems, among others. Other aspects, embodiments, and advantages of the invention will become apparent by studying the detailed description that follows and by referencing the accompanying drawings.

### BRIEF DESCRIPTION OF THE DRAWINGS

FIG. 1A is a diagram showing an overview of an integrated interoperable safety analysis process according to an embodiment of the invention, and that can also act as a training device.

FIG. 1B is a diagram showing the manner by which FIGS. 3A-3H are to be laid out to properly show the detailed safety analysis (2^{nd}) phase of FIG. 1A in more detail.

FIG. 1C is a diagram showing the manner by which FIGS. 8A-8G are to be laid out to properly show the safety disposition (3^{rd}) phase and the sustained system safety engineering (sustenance) (4) phase of FIG. 1A in more detail.

FIGS. 2A and 2B are diagrams showing the safety program definition (1^{st}) phase of FIG. 1A in more detail, according to an embodiment of the invention.

FIGS. 3A, 3B, 3C, 3D, 3E, 3F, 3G, and 3H are diagrams showing the detailed safety analysis (2^{nd}) phase of FIG. 1A in more detail, according to an embodiment of the invention.

FIGS. 4A and 4B are diagrams showing the Rigor Level One software analysis of FIG. 3A in more detail, according to an embodiment of the invention.

FIGS. 5A and 5B are diagrams showing the Rigor Level Two software analysis of FIG. 3A in more detail, according to an embodiment of the invention.

FIG. 6 is a diagram showing the Rigor Level Three software analysis of FIG. 3A in more detail, according to an embodiment of the invention.

FIG. 7 is a diagram showing the Rigor Level Four software analysis of FIG. 3A in more detail, according to an embodiment of the invention.

FIGS. 8A, 8B, 8C, 8D, 8E, 8F, and 8G are diagrams showing the safety disposition (3^{rd}) phase and the sustained system safety engineering (sustenance) (4^{th}) phase of FIG. 1A in more detail, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, and other changes may be made without departing from the spirit or scope of the present invention. For instance, whereas the invention is substantially described in relation to a naval combat system, it is applicable to other types of military and non-military systems as well. The following detailed description is, therefore, not to be taken in a limiting sense, and the scope of the present invention is defined only by the appended claims.

Overview

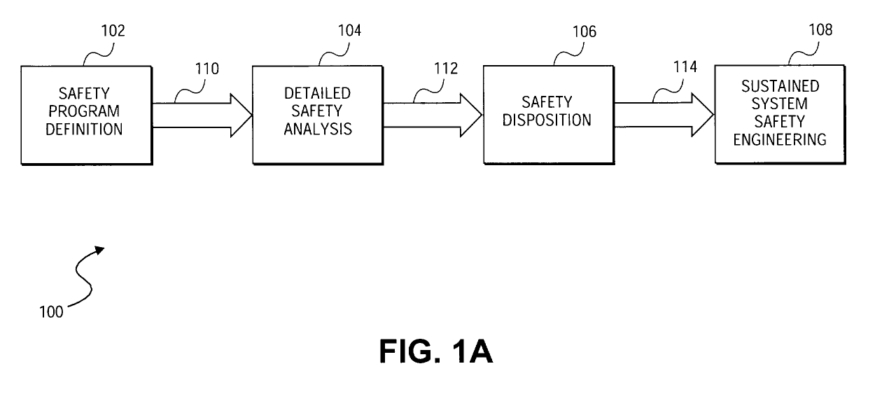

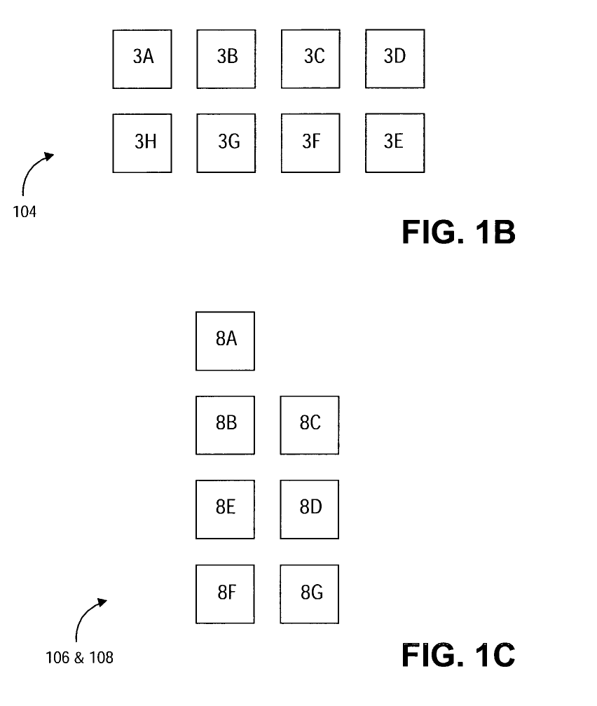

FIG. 1A shows an overview of an integrated interoperable safety analysis process 100 according to an embodiment of the invention. As will become apparent by reading the detailed description, the process is thorough, efficient, cost-effective, technically efficient, systematic, and maintainable. The process 100 has four phases: a safety program definition phase 102, a detailed safety analysis phase 104, a safety disposition phase 106, and a sustained system safety engineering phase 108. The phases are preferably stepped through as indicated by the arrows 110, 112, and 114. Each phase is described in detail in a subsequent section of the detailed description.

The process 100 can be utilized and implemented in a number of different scenarios and applications, such as, for example, naval surface weapon systems. In such instance, the process 100 enables integration of the software safety analysis with the system safety efforts themselves. The process 100 can also enable the tracking of ship-level combat system hazards.

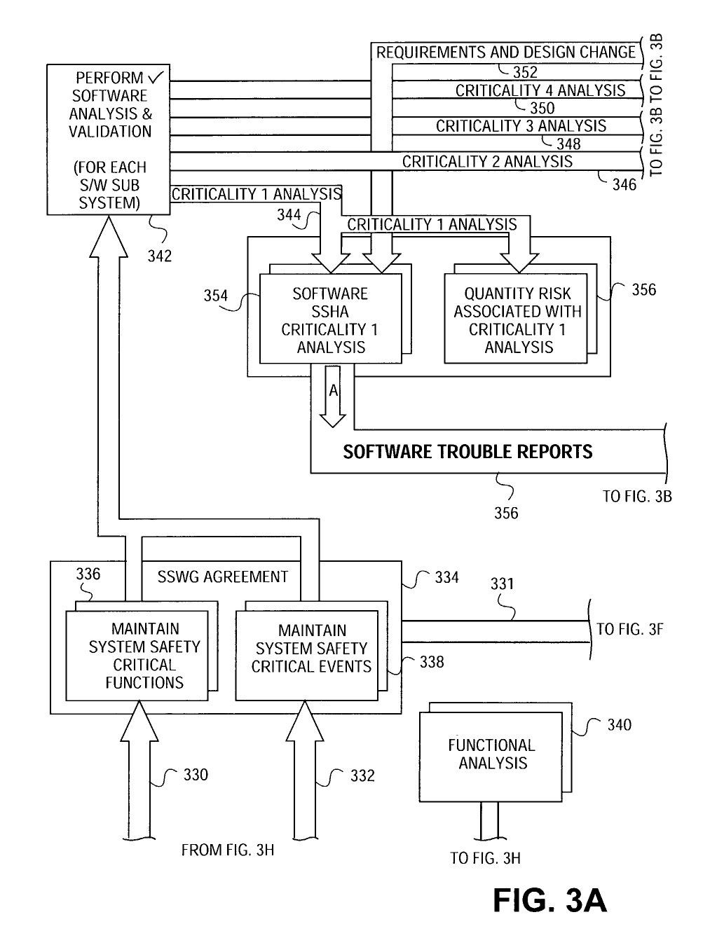

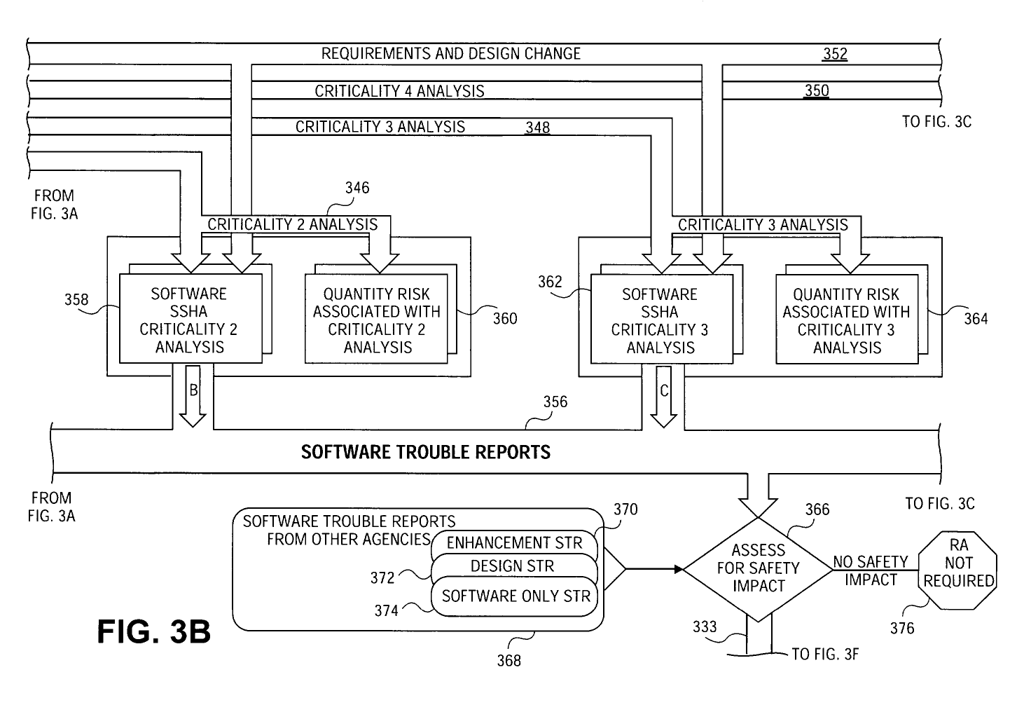

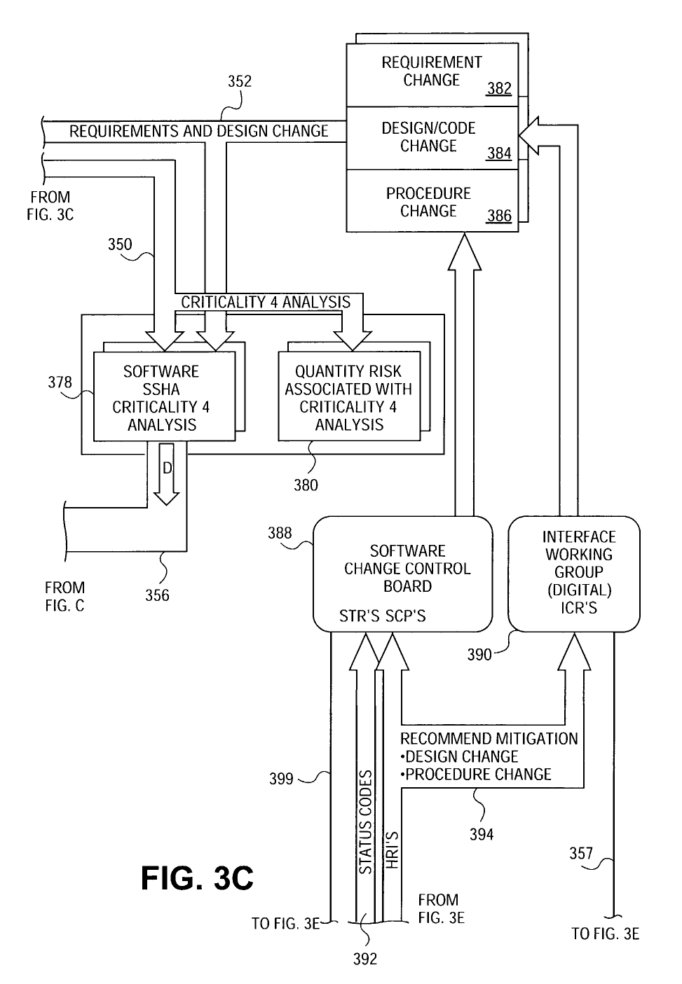

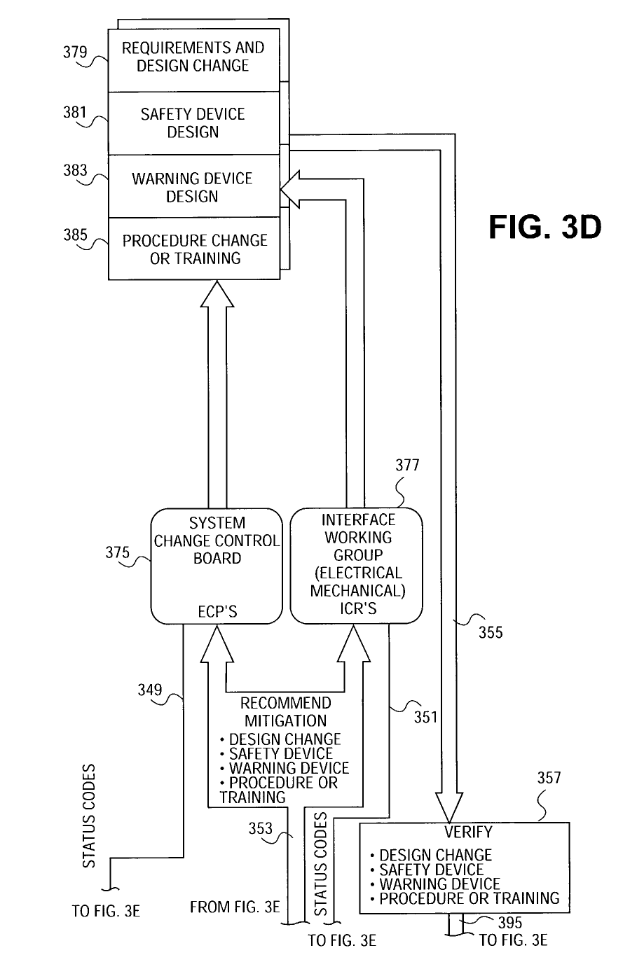

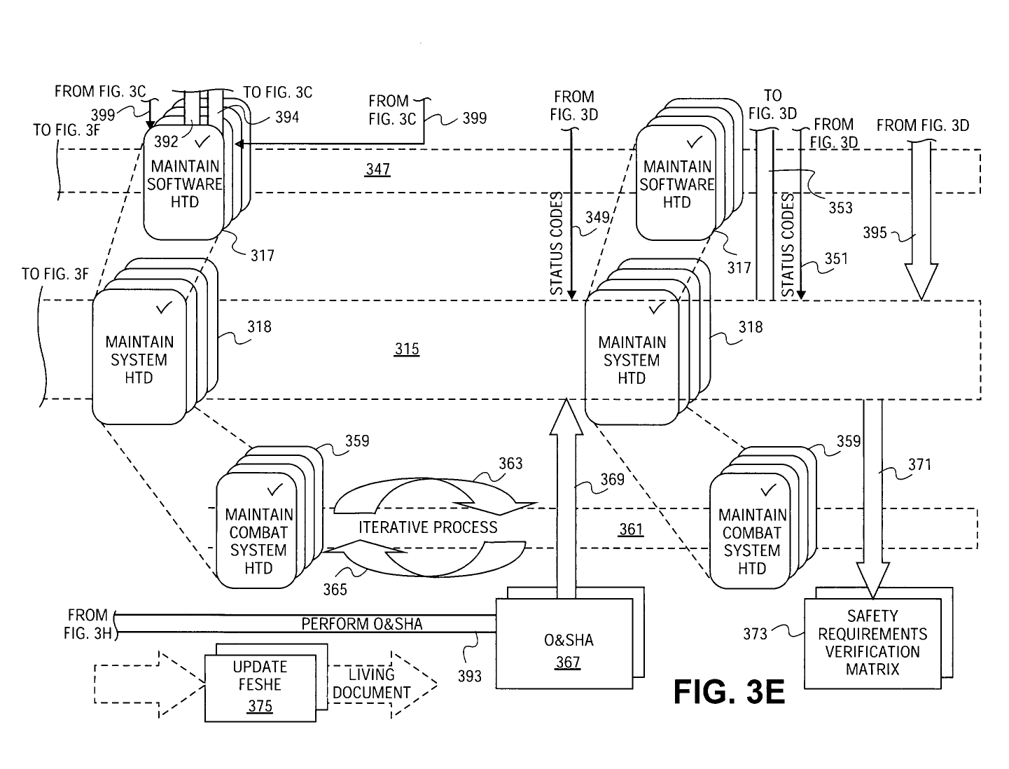

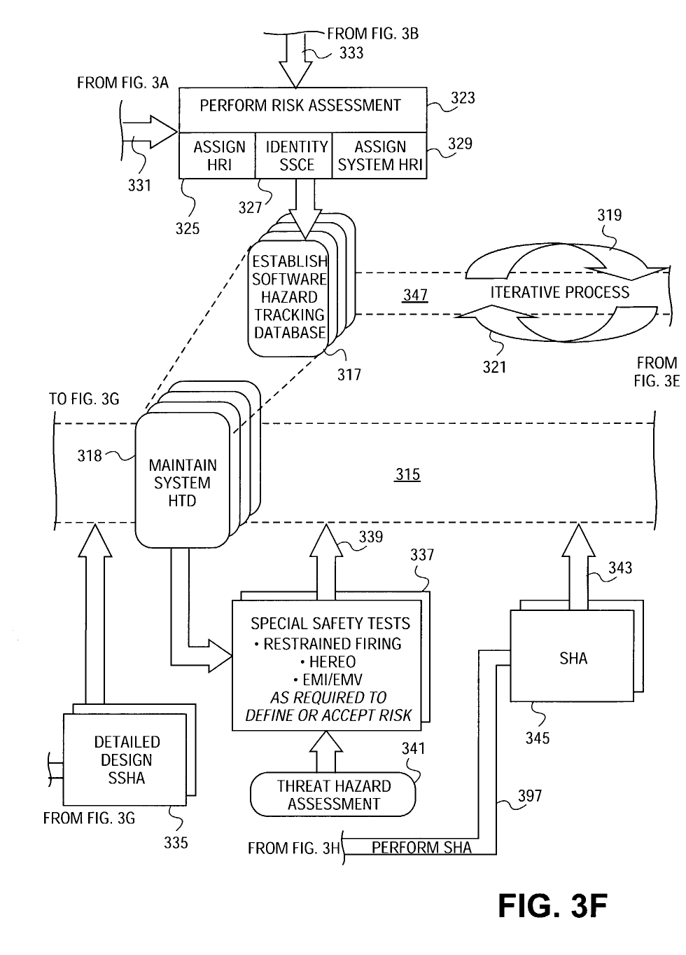

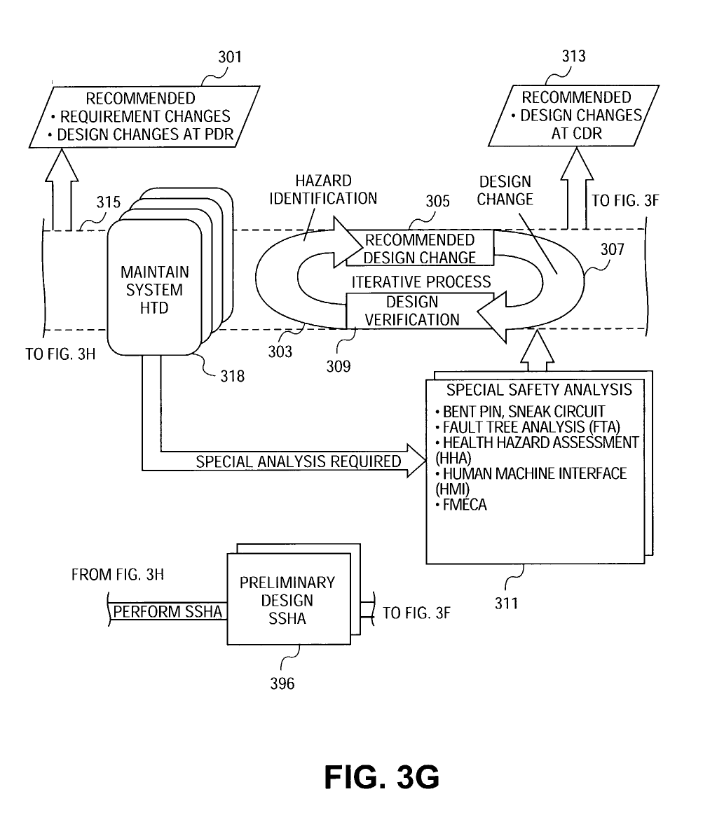

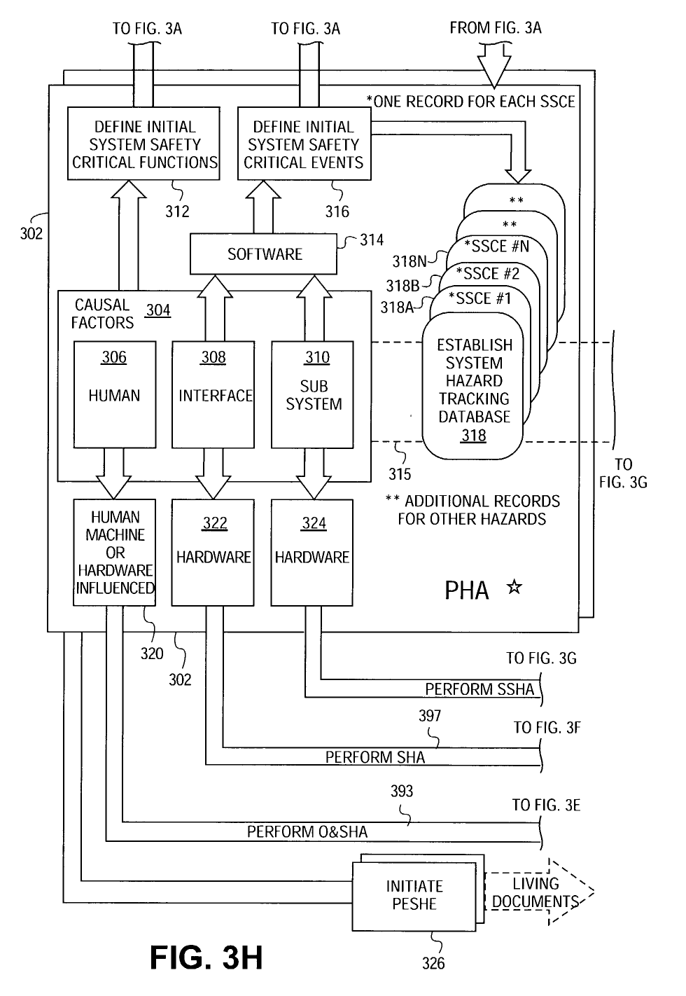

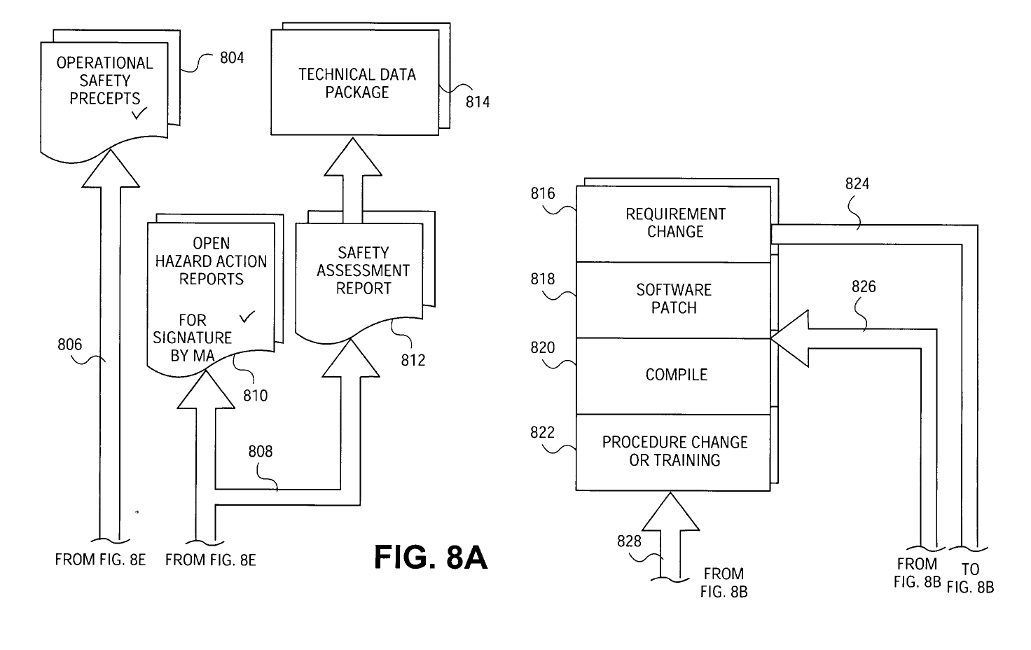

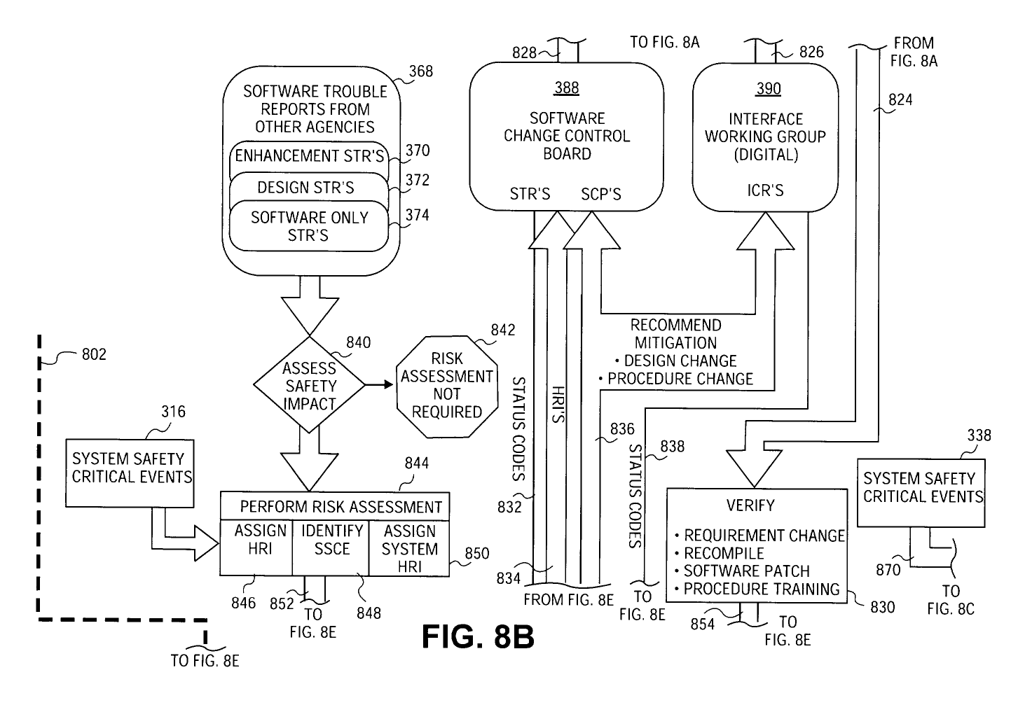

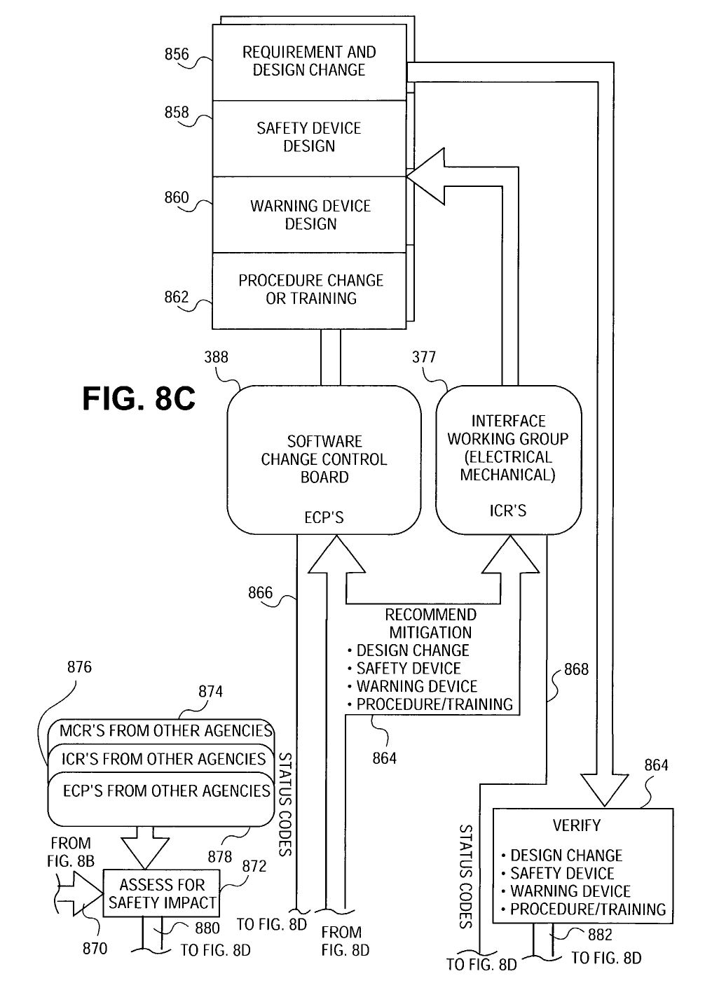

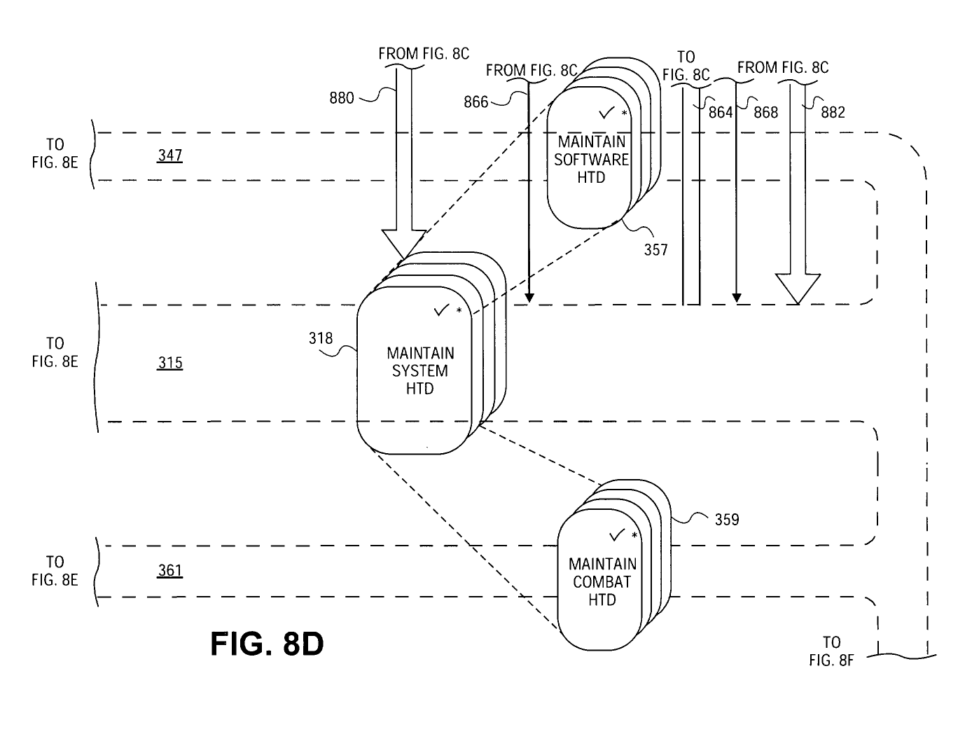

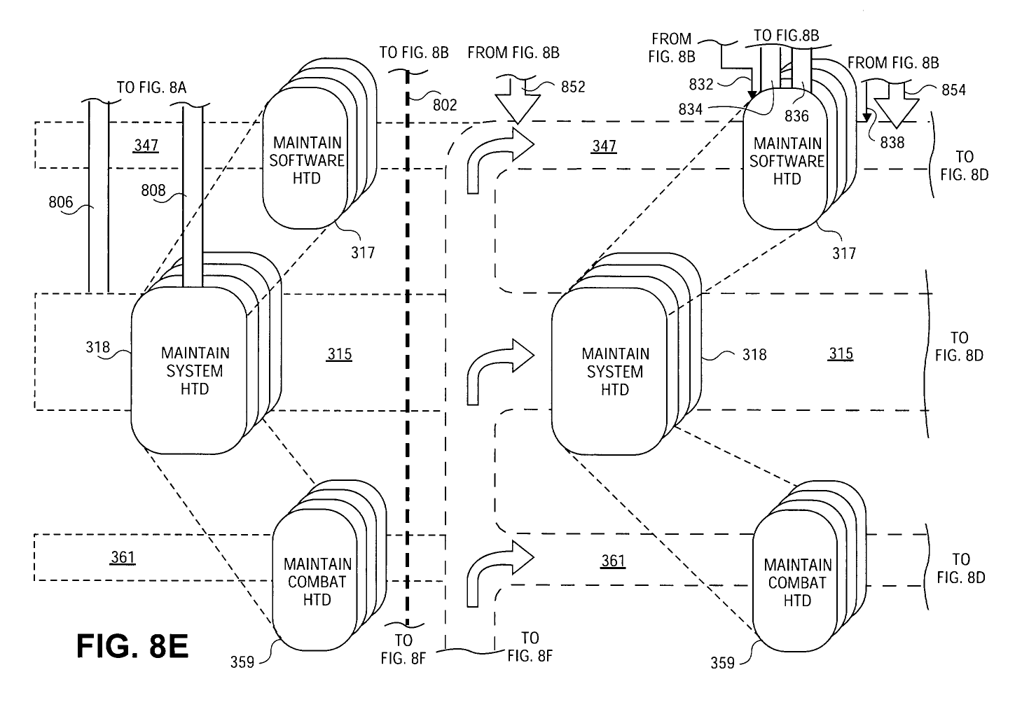

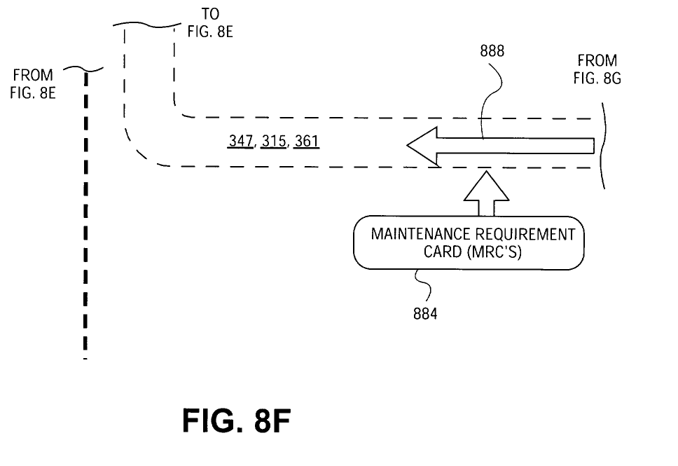

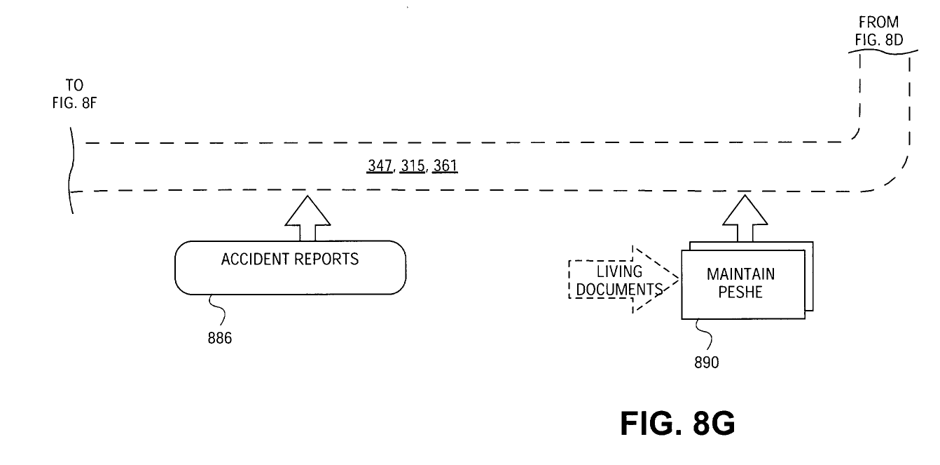

In the sub-sections of the detailed description that follow, reference is made to diagrams. Rounded boxes in these diagrams represent inputs, such as critical inputs, to the process 100. Rectangular boxes represent products. A starred item indicates that a safety design review, such as a critical safety design review, is performed in conjunction with the item. A check-marked item indicates that an engineer review, such as a staff engineer review, occurs in conjunction with the item. Similarly, an asterisked and check-marked item indicates that an engineer review, as required or appropriate, occurs in conjunction with the item. Furthermore, FIG. 1B shows the manner by which FIGS. 3A-3H should be laid out to view the detailed safety analysis phase 104, whereas FIG. 1C shows the manner by which FIGS. 8A-8G should be laid out to view the safety disposition phase 106, and the sustenance phase 108.

Safety Program Definition

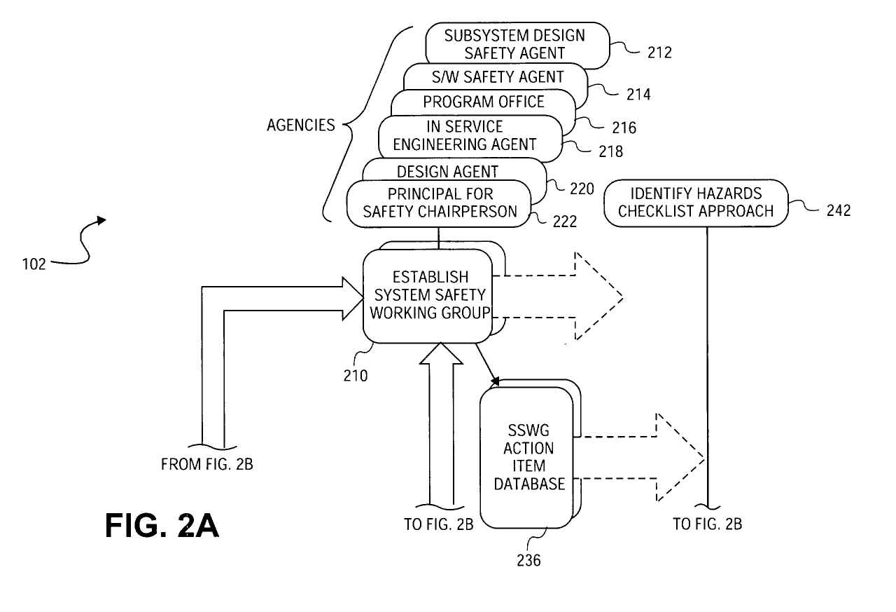

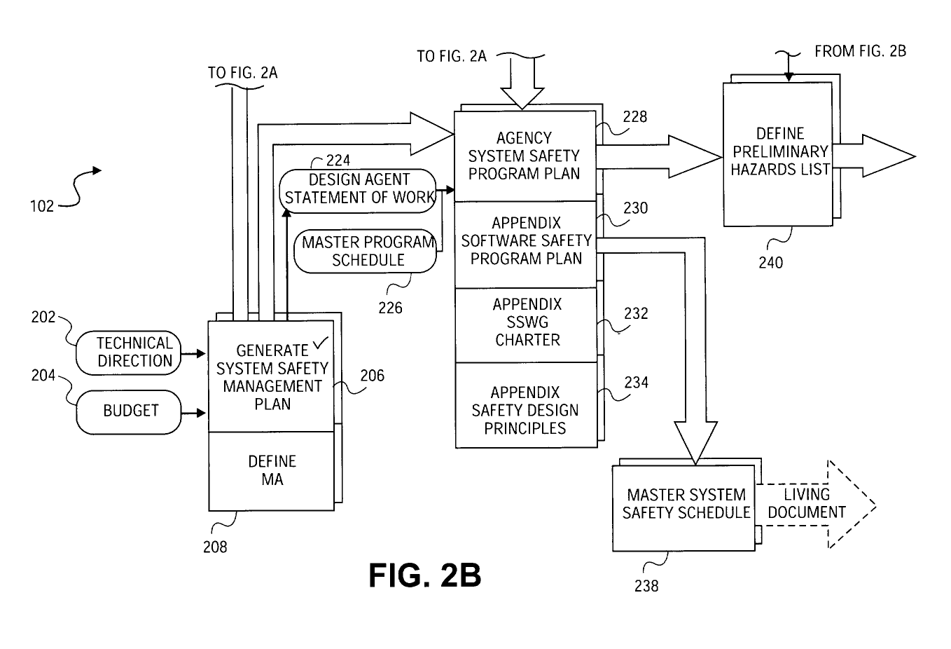

FIGS. 2A and 2B show the safety program definition phase 102 of FIG. 1A in detail, according to an embodiment of the invention. The description of FIGS. 2A and 2B is provided as if these two figures made up one large figure. Therefore, some components indicated by reference numerals reside only in FIG. 2A, whereas other components indicated by reference numerals reside only in FIG. 2B.

A technical direction input 202 and a budget input 204 are provided to generate a system safety management plan 206. In conjunction with this, management acceptance 208 is defined. As an example only, the management acceptance 208 may have four levels, each level appropriate to the risk associated with a particular item. A high risk means that the risk must be accepted by the Assistant Secretary of the Navy (Research, Development, and Acquisition) (ASN/RDA). A serious risk means that the risk must be accepted by the Program Executive Officer (PEO). A medium risk means that the risk must be accepted by the program manager. A low risk means that the risk must be accepted by the Principal for Safety (PFS), and forwarded to the program manager for informational purposes.

Once the system safety management plan 206 has been generated, three tasks occur. First, a system safety working group (SSWG) 210 is established as the safety body of knowledge for that weapon system. The SSWG 210 maybe made up of different parties, such as a subsystem design safety agent 212, a software safety agent 214, a program office 216, an in-service engineering agent 218, a design agent 220, and a principal for safety chairperson 222. Next, the design agent 220 in particular provides a design agent statement of work 224. Finally, the SSWG 210, based on the system safety management plan 206, the statement of work 224, and a master program schedule 226, generates an agency system safety program plan 228.

As appendices to the agency system safety program plan 228, a software safety program plan 230, a SSWG charter 232, and safety design principles 234 may also be generated. Examples of the safety principles 234 are as follows. First, all system safety programs will follow the safety order of precedence to minimize safety risk by: eliminating the hazard through design; controlling the hazard through design safety devices; using warnings at the hazard site; and, using procedures and training. Second, from any non-tactical mode, such as training or maintenance, there shall be at least two independent actions required to return to the tactical mode. Third, the fire control system shall have positive identification of the ordnance/weapon present in the launcher. Identification shall extend to all relevant safety characteristics of the ordnance/weapon. Fourth, there shall be no single or double point or common mode failures that result in a high or serious safety hazard. Fifth, all baseline designs and any changes to approved baseline designs shall have full benefit of a system safety program appropriate to the identified maximum credible event (MCE).

The SSWG 210 also generates an SSWG action item database 236. From the software safety program plan 230, a master system safety schedule 238 is generated, which is a living document that dynamically changes. The agency system safety program plan 228, once generated, also leads to defining a preliminary hazards list 240. The preliminary hazards list 240 is additionally based on a hazards checklist approach 242 that has previously been defined.

Detailed Safety Analysis

FIGS. 3A-3H show the detailed safety analysis phase 104 of FIG. 1A in detail, according to an embodiment of the invention, and should be laid out as indicated in FIG. 1B. Starting first at FIG. 3H, the Preliminary Hazard Analysis (PHA) 302 is established such that there is a set of system safety critical event (SSCE) records (or, system hazard tracking database) 318, including the SSCE records 318a, 318b, . . . , 318. The PHA 302 includes causal factors 304, including human causal factors 306, interface causal factors 308, and sub-system causal factors 310. The causal factors 304 contribute to the definition of initial system safety criticality functions 312. The interface factors 308 and the sub-system factors 310 input to software 314, which is used to define initial system safety critical events 316. The critical events 316 are used to generate the set of SSCE records 318. The human factors 306 are human, machine, or hardware influenced, as indicated by the box 320, whereas the interface factors 308 and the sub-system factors 310 are hardware influenced, as indicated by the boxes 322 and 324, respectively. The PHA 302 is used to initiate the Programmatic Environment, Safety, and Health Evaluation (PESHE) 326, which is a living document. A process 315 starts at the causal factors 304, leads to the records 318, and continues on to FIG. 3G, as will be described.

Software safety criticality can be categorized into autonomous, semi-autonomous, semi-autonomous with redundant backup, influential, and no safety involvement categories. The autonomous category is where the software item exercises autonomous control over potentially hazardous hardware systems, sub-systems, or components without the possibility of intervention to preclude the occurrence of a hazard. The semi-autonomous category is where the software item displays safety-related information or exercises control over potentially hazardous hardware systems, sub-systems, or components with the possibility of intervention to preclude the occurrence of a hazard.

The semi-autonomous with redundant backup category is where the software item displays safety-related information or exercises control over potentially hazardous hardware systems, sub-systems, or components, but where there are two or more independent safety measures with the system, and external to the software item. The influential category is where the software item processes safety-related information but does not directly control potentially hazardous hardware systems, sub-systems, or components. The no safety involvement category is where the software item does not process safety-related data, or exercise control over potentially hazardous hardware systems, sub-systems, or components.

Referring next to FIG. 3A, functional analysis 340 contributes to the PHA 302 of FIG. 3H. Furthermore, the initial system safety criticality functions 312 of FIG. 3H and the initial system safety critical events 316 of FIG. 3H are used to generate the SSWG agreement 334, as indicated by the arrows 330 and 332, respectively. The SSWG agreement 334 includes maintaining system safety criticality functions 336 and maintaining system safety critical events 338, which are coincidental with the critical events 316. Examples of system safety critical functions 336 include ordnance selection, digital data transmission, ordnance safing, and system mode control.

Ordnance selection is the process of designating an ordnance item and establishing an electrical connection. Digital data transmission is the initiation, transmission, and processing of digital information that contributes to the activation of ordnance events or the accomplishment of other system safety criticality functions. Ordnance safing is the initiation, transmission, and processing of electrical signals that cause ordnance to return to a safe condition. This includes the monitoring functions associated with the process. System mode control includes the events and processing that cause the weapon system to transition to a different operating mode and the proper use of electrical data items within that operating mode.

Still referring to FIG. 3A, examples of system safety critical events 338 include critical events in tactical, standby, training, and all modes. Critical events in the tactical mode include firing into a no-fire zone, incorrect target identification, restrained firing, inadvertent missile selection, and premature missile arming. Critical events in the standby mode include inadvertent missile arming and inadvertent missile selection. Critical events in the training mode include restrained firing and inadvertent missile selection. Critical events in all modes include inadvertent launch, inadvertent missile release, and inadvertent missile battery activation.

Still referring to FIG. 3A, the SSWG agreement 334 leads to the performance of software analysis and validation 342 for each software sub-system. These include a Rigor Level One analysis 344, a Rigor Level Two analysis 346, a Rigor Level Three analysis 348, and a Rigor Level Four analysis 350. The Rigor Level One analysis 344 includes software Subsystem Hazard Analysis (SSHA) criticality one analysis 354, which is affected by requirements and design changes 352, and also includes quantity risk associated with the Rigor Level One analysis 356. The result of the Rigor Level One analysis is software trouble reports 356.

In FIG. 3B, the Rigor Level Two analysis 346 includes software SSHA Rigor Level Two analysis 358, which is affected by the requirements and design changes 352, and also includes quantity risk associated with the Rigor Level Two analysis 360. Similarly, the Rigor Level Three analysis 348 includes software SSHA Rigor Level Three analysis 362, which is affected by the requirements and design changes 352, and also includes quantity risk associated with the Rigor Level Three analysis 364. Both the software SSHA Rigor Level Two analysis 358 and the software SSHA Rigor Level Three analysis 362 results in the software trouble reports 356.

Still referring to FIG. 3B, the software trouble reports (STR's) 368 are used to conduct an assessment for safety impact 366. The STR's 368 include enhancement STR's 370, design STR's 372, and software-only STR's 374. One result of the assessment 366 is that there is no safety impact, such that a Risk Assessment (RA) is not required, as indicated by the box 376.

In FIG. 3C, the Rigor Level Four analysis 350 includes software SSHA criticality four analysis 378, which is affected by the requirements and design changes 352, and also includes quantity risk associated with the Rigor Level Four analysis 380. The Rigor Level Four analysis also results in the software trouble reports 356. The requirements and design changes 352 result from requirement changes 382, design or code changes 384, and procedure changes 386. The procedure changes 386 specifically are determined by the software change control board 388, whereas the design or code changes 384 are specifically determined by the interface working group (digital) 390. The software change control board 388 considers both STR's resulting from status codes 392, and Software Change Proposal (SCP's) resulting from Hazard Risk Index (HRI's), and recommended mitigation, such as design changes and procedure changes, 394. The interface working group 390 considers Interface Change Requests (ICR's) resulting from HRI'S, and recommendation mitigation, such as design changes and procedure changes, 394.

Referring next to FIG. 3G, the hardware influence indicated by box 324 of FIG. 3H results in the performance of a preliminary design SSHA 396. Within the process 315, the system hazard tracking database (HTD) 318 is maintained. Furthermore, requirement changes and design changes at Preliminary Design Review (PDR) are recommended, as indicated by the box 301. An iterative process involving hazard identification 303 leads to recommended design changes 305, and the design changes 307 lead to design verification 309. This process is also affected by the special safety analysis 311 that leads from maintaining the system HTD 318. The special analysis 311 includes bent pin analysis, sneak circuit analysis, fault tree analysis, health hazard assessments, human machine interface analysis, and Failure Mode Effects and Criticality Analysis (FMECA). Finally, design changes at Critical Design Review (CDR) are recommended, as indicated by the box 313.

Referring next to FIG. 3F, within the process 315, the system HTD 318 is again maintained. This includes the establishment of the software HTD 317, which is an iterative process 347, as indicated by the arrows 319 and 321. The establishment is also affected by the performance of a risk assessment 323, including assigning an HRI 325, identifying an SSCE 327, and assigning a system HRI 329. The risk assessment 323 is based on the SSWG agreement 336 of FIG. 3A, as indicated by the arrow 331, as well as the safety impact assessment 366 of FIG. 3B, as indicated by the arrow 333. Furthermore, part of the process 315 is a detailed design SSHA 335, resulting from the preliminary design SSHA 396 of FIG. 3G.

Still referring to FIG. 3F, maintenance of the system HTD 318 leads to special safety tests 337, which affects the process 315, as indicated by the arrow 339. The special safety tests 337 can include restrained firing, Hazards of Electromagnetic Radiation to Ordnance (HERO), electromagnetic vulnerability (EMV) and electromagnetic interference (EMI) testing, and so on. Hazard assessment threats 341 also influence the special safety tests 337. An System Hazard Analysis (SHA) 345 is also performed, leading from the hardware influences of box 322 of FIG. 3H, as indicated by the arrow 397, and the SHA 345 affects the process 315, as indicated by the arrow 343.

Referring next to FIG. 3E, within the 315, the system HTD 318 is again maintained. Specifically, the software HTD 317 is maintained within the process 347. The software HTD 317 is affected by the determinations of the software change control board 388 of FIG. 3C, as indicated by the arrow 399, and also results in status codes 392 and HRI's 394 that are provided to the board 388 of FIG. 3C and the group 390 of FIG. 3C. Status codes 349 and 351, from FIG. 3D, affect the process 315, as does verification 357 of FIG. 3D, as indicated by the arrow 395. The process 315 further leads to recommended mitigation 353 in FIG. 3D.

Still referring to FIG. 3E, a combat system HTD 359 is maintained in an iterative process 361, as indicated by the arrows 363 and 365. An Operating and Support Hazard Analysis (O&SHA) 367 is performed, based on the human machine or hardware influences 320 of FIG. 3H, as indicated by the arrow 393. The O&SHA 367 also affects the process 315, as indicated by the arrow 369. As indicated by the arrow 371, the process 315 leads to a safety requirements verification matrix 373. The PESHE 375 is also updated, and is a living document.

Referring finally to FIG. 3D, the system change control board 375 generates status codes 349, as a result of the Engineering Change Proposals (ECP's) from the recommended mitigation 353. Similarly, the interface working group (electrical mechanical) 377 generates status codes 351, as a result of the ICR's from the recommended mitigation 353. The recommendation mitigation 353 can include design changes, safety device additions, warning device additions, or changes in procedures or training.

Still referring to FIG. 3D, requirements and design changes 379 include safety device design 381, warning device design 383, and procedure changes or training 385. The control board 375 generates the procedure changes or training 385. The working group 377 generates the safety device design 381 and the warning device design 383. The requirements and design changes 379 are then verified, as indicated by the arrow 355. The verification 357 includes specifically verification of the design changes, safety devices, warning devices, and procedures or training.

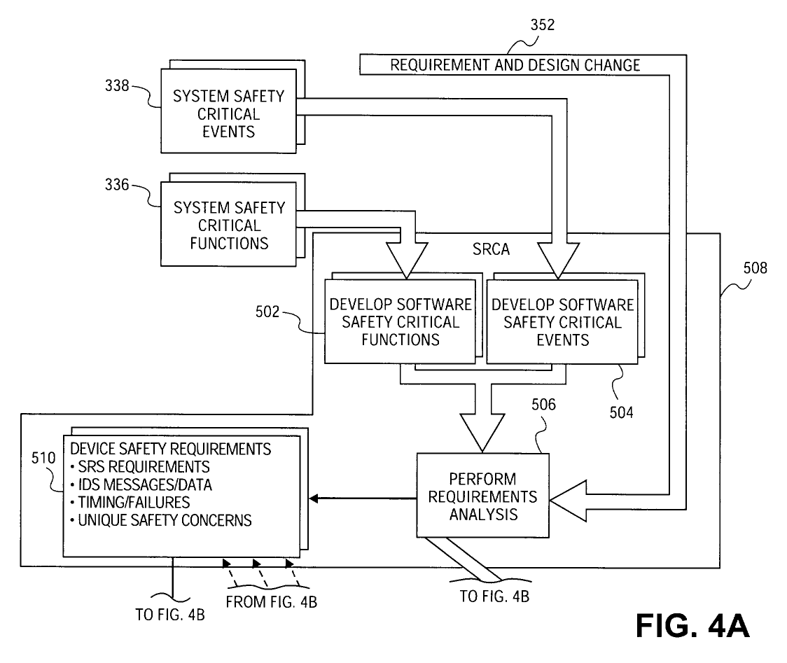

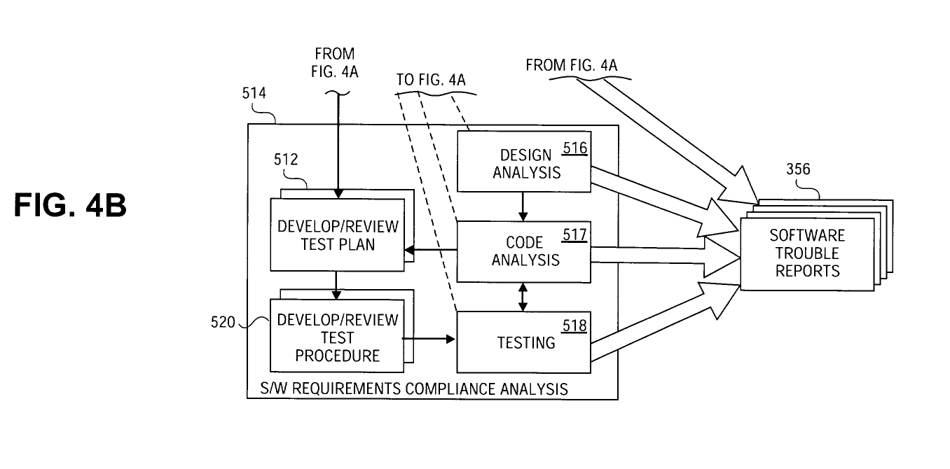

FIGS. 4A and 4B show the criticality one software analysis 344 of FIG. 3A in detail, according to an embodiment of the invention. The description of FIGS. 4A and 4B is provided as if these two figures made up one large figure. Therefore, some components indicated by reference numerals reside only in FIG. 4A, whereas other components indicated by reference numerals reside only in FIG. 4B.

The system safety critical events 338 are used to develop software safety critical events 504 in the Software Requirements Criteria Analysis (SRCA) 508, whereas the system safety critical functions 336 are used to develop software safety critical functions 502 in the SRCA 408. The functions 502 and the events 504, along with the requirements and design changes 352, are used to perform a requirements analysis 506. The requirements analysis 406 leads to device safety requirements 510, including Software Requirement Specification (SRS) requirements, Interface Design Specification (IDS) messages and data, timing and failures, and unique safety concerns.

The device safety requirements 510 are used to develop or review a test plan 512, which is part of a software requirements compliance analysis 514. A design analysis 516 also affects the test plan 512, and the design analysis 516 additionally affects the device safety requirements 510. The design analysis 516 affects code analysis 517, which affects testing 518, which itself affects the device safety requirements 510. After development and review of the test plan 512, including use of the code analysis 517, test procedures 520 are developed and reviewed, on which basis the testing 518 is accomplished. The testing 518, along with the design analysis 516 and the code analysis 517, also affect the software trouble reports 356.

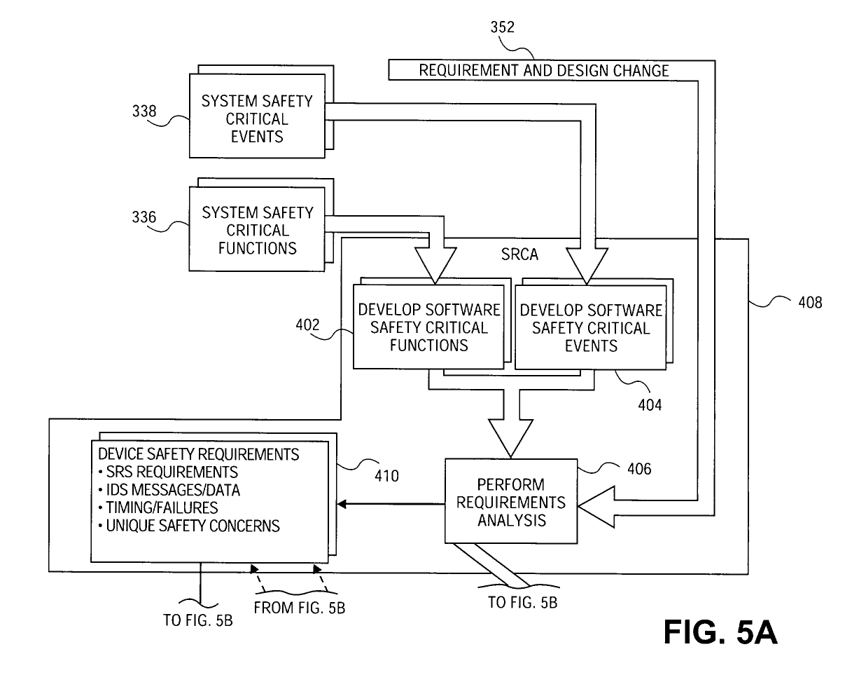

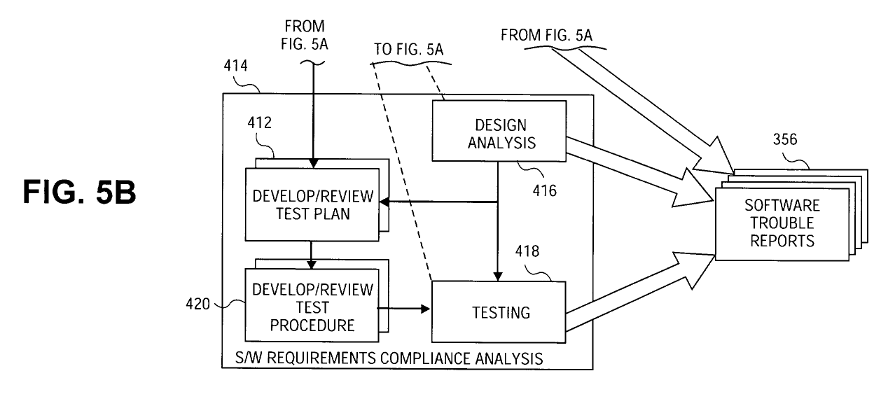

FIGS. 5A and 5B show the Rigor Level Two software analysis 346 of FIG. 3A in detail, according to an embodiment of the invention. The description of FIGS. 5A and 5B is provided as if these two figures made up one large figure. Therefore, some components indicated by reference numerals reside only in FIG. 5A, whereas other components indicated by reference numerals reside only in FIG. 5B.

The system safety critical events 338 are used to develop software safety critical events 404 in the SRCA 408, whereas the system safety critical functions 336 are used to develop software safety critical functions 402 in the SRCA 408. The functions 402 and the events 404, along with the requirements and design changes 352, are used to perform a requirements analysis 406. The requirements analysis 406 leads to device safety requirements 410, including SRS requirements, IDS messages and data, timing and failures, and unique safety concerns.

The device safety requirements 410 are used to develop or review a test plan 412, which is part of a software requirements compliance analysis 414. A design analysis 416 also affects the test plan 412, and the design analysis 416 additionally affects the device safety requirements 410. The design analysis 416 affects testing 418, which itself affects the device safety requirements 410. After development and review of the test plan 412, test procedures 420 are developed and reviewed, on which basis the testing 418 is accomplished. The testing 418, along with the design analysis 416, also affect the software trouble reports 356.

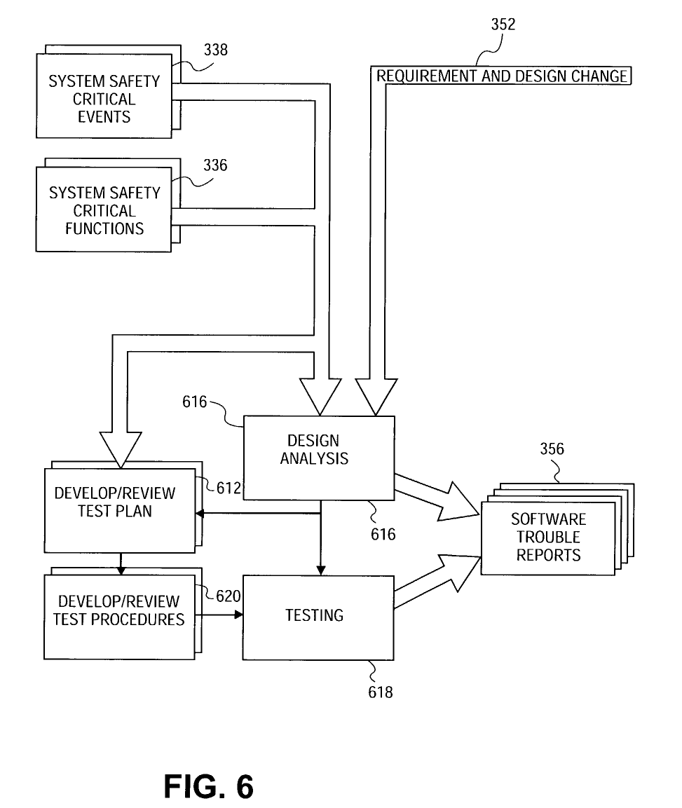

FIG. 6 shows the Rigor Level Three software analysis 348 of FIG. 3A in detail, according to an embodiment of the invention. The system safety critical events 338, the system safety critical functions 336, and the requirements and design changes 352, are used to conduct a design analysis 616. The design analysis 616, along with the events 338 and the functions 336, are used to develop and review a test plan 612, from which test procedures 620 are developed and reviewed. On the basis of the test procedures 620, and the design analysis 616, testing 618 is accomplished. The design analysis 616 and the testing 618 results in software trouble reports 356.

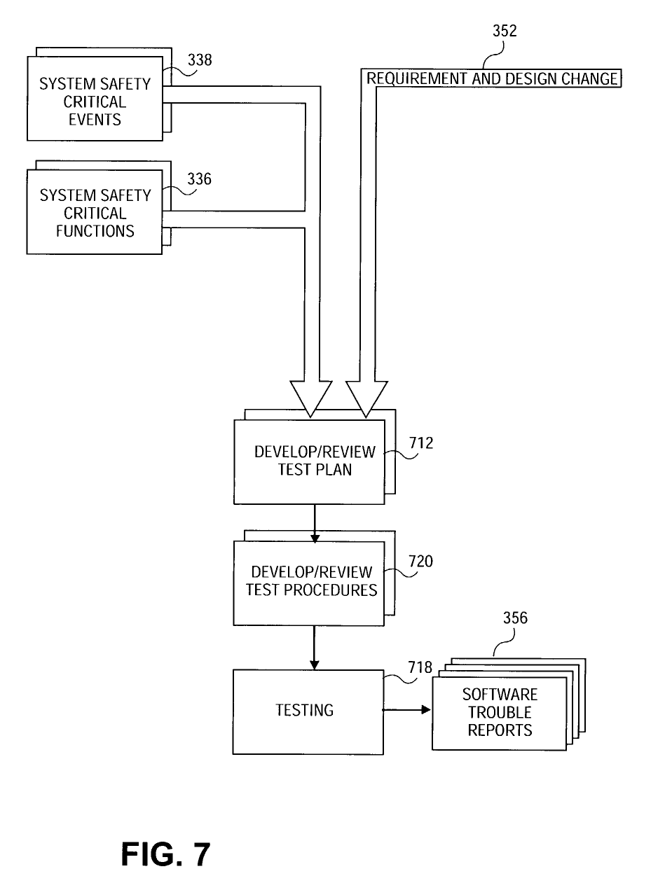

FIG. 7 shows the Rigor Level Four software analysis 350 of FIG. 3A in detail, according to an embodiment of the invention. The system safety critical events 338, the system safety critical functions 336, and the requirements and design changes 352, are used to develop and review a test plan 712, from which test procedures 720 are developed and reviewed. On the basis of the test procedures 720, testing 718 is accomplished. The testing 718 results in software trouble reports 356.

Safety Disposition and Sustenance

FIGS. 8A-8G show the safety disposition phase 106 of FIG. 1A and the sustained system safety engineering (sustenance) phase 108 of FIG. 1A in detail, according to an embodiment of the invention, and should be laid out as indicated in FIG. 1C. Starting first at FIG. 8E, the emphasized dotted line 802 separates the safety disposition phase 106 from the sustenance phase 108. The safety disposition phase 106 is to the left of the dotted line 802, whereas the sustenance phase 108 is to the right of the dotted line 802.

Still referring to FIG. 8E, in the safety disposition phase 106 to the left of the dotted line 802, the system HTD 318 is still maintained as part of the process 315. Similarly, the software HTD 317 is still maintained as part of the process 347, and the combat HTD is still maintained as part of the process 361. This is also the case in the sustenance disposition phase 108 to the right of the dotted line 802, as is shown in FIG. 8E.

Referring next to FIG. 8A, operational safety precepts 804 result from the process 315 of FIG. 8E, as indicated by the arrow 806. The following are examples of operational safety precepts. No electrical power shall be applied to a weapon without intent to initiate. There shall be no mixing of simulators and tactical rounds within a launcher. There shall be no intermixing of development or non-developmental weapons, ordnance, programs, or control systems with tactical systems without documented specific approval. The system shall be operated and maintained only by trained personnel using authorized procedures. Front-end radar simulation or stimulation shall not be permitted while operating in a tactical mode.

Still referring to FIG. 8A, open hazard action reports 810, for signature by the Managing Activity (MA), result from the maintenance of the system HTD 318 of FIG. 8E, as indicated by the arrow 808. Also resulting from the maintenance of the system HTD 318 of FIG. 8E, as indicated by the arrow 808, is a Safety Assessment Report (SAR) 812. The safety assessment report 812 itself results in the generation of a technical data package 814.

Still referring to FIG. 8A, requirement changes 816, software patches 818, compiles 820, and procedure changes or training 822 can result from the arrows 826 and 828. The arrow 826 is from the interface working group 390 of FIG. 8B, whereas the arrow 828 is from the software change control board 388 of FIG. 8B. Furthermore, the requirement changes 816, software patches 818, compiles 820, and procedure changes or training 822, are verified as indicated as the verification 830 of FIG. 8B, as pointed to by the arrow 824.

Referring now to FIG. 8B, the verification 830 enters the process 347 of FIG. 8E as indicated by the arrow 854. The software change control board 388 considers STR's and SCP's from the HRI's 834, and the recommended mitigations 836, which can be design changes and procedure changes. The HRI's 834 and the recommended mitigations 836 result from the maintenance of the software HTD 317 in FIG. 8E. As feedback the board 388 generates status codes 832. The interface working group (digital) considers ICR's based on the recommended mitigations 836, and generates status codes 838. STR's from other agencies 368, such as enhancement STR's 370, design STR's 372, and software-only STR's 374, are used to assess the safety impact 840, which can indicate that a risk assessment is not required, as indicated by the box 842. If a risk assessment 844 is required, however, then the system safety critical events 316 are used to assign HRI's 846, identify SSCE's 848, and assign system HRI's 850. These are then fed into the process 347, and thus the processes 315 and 361, of FIG. 8E, as indicated by the arrow 852.

Referring next to FIG. 8C, requirement and design changes 856, safety device designs 858, working device designs 860, and procedure changes or training 862 are verified as indicated by the verification 864, and are generated by the software change control board 388 and the interface working group (electrical mechanical) 377. The software change control board 388 considers ECP's based on the recommendation mitigations 864, and the working group 377 considers ICR's based on the recommendation mitigations 864. The recommended mitigations 864 can include design changes, safety device additions, warning device additions, and changes in procedures and/or training. The board 388 provides status codes 866, whereas the working group 377 provides status codes 868. Furthermore, system safety critical events 338 from FIG. 8B, as indicated by the arrow 870, are used to make a safety impact assessment 872. The assessment 872 is also based on ICR's from other agencies 876 and ECP's from other agencies 878.

Referring next to FIG. 8D, further system HTD maintenance 318, software HTD maintenance 357, and combat HTD maintenance 359 is accomplished. The maintenance of the system HTD is based on the safety impact assessment 872 of FIG. 8C, as indicated by the arrow 880. The process 315 is influenced by the status codes 866. The process 315 also results in the recommended mitigations 864 of FIG. 8C, and is influenced by the status codes 868 and the verification 864 of FIG. 8C. As shown in the far right side of FIG. 8D, the processes 347, 315, and 361 are influenced by and influence one another, as they ultimately merged with one another.

Referring next and finally to FIGS. 8F and 8G, Maintenance Requirement Cards (MRC's) 884 in FIG. 8F and accident reports 886 in FIG. 8G affect the looping back of the combined processes 347, 315, and 361 from FIG. 8D (to the top of FIG. 8G) back to FIG. 8E (to the top of FIG. 8F), as indicated by the arrow 888 in FIG. 8F. Furthermore, the PESHE 890 affects the combined processes 347, 315, and 361, and is a living document.

Conclusion

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. For instance, whereas the invention has been substantially described in relation to a naval combat system, it is applicable to other types of military and non-military systems as well. Therefore, it is manifestly intended that this invention be limited only by the claims and equivalents thereof.

What is claimed is:

1. A safety analysis system comprising:
a safety program definition phase in which a safety program is defined;
a detailed safety analysis phase to analyze the safety of the system;
a safety disposition phase to dispose the safety program as has been analyzed; and,
a sustained system safety engineering phase to sustain the safety program as has been analyzed and disposed.

2. The system of claim 1, wherein the safety program definition phase comprises generation of a system safety management plan.

3. The system of claim 2, wherein the safety program definition phase further comprises definition of a system safety program plan, definition of a software safety program plan, and definition of safety design principles, leading from the generation of the system safety management plan.

4. The system of claim 3, wherein the safety program definition phase further comprises definition of a preliminary hazards list, leading from definition of the system safety program plan.

5. The system of claim 3, wherein the safety program definition phase further comprises definition of a master system safety schedule.

6. The system of claim 1, wherein the detailed safety analysis phase comprises establishment of a system hazard tracking database comprising a plurality of records corresponding to defined system safety critical events based at least in part on causal factors, system safety critical functions also defined.

7. The system of claim 6, wherein the detailed safety analysis phase further comprises establishment of a software hazard tracking database as part of the system hazard tracking database.

8. The system of claim 7, wherein the detailed safety analysis phase further comprises maintenance of the software hazard tracking database.

9. The system of claim 6, wherein the detailed safety analysis phase further comprises maintenance of the system hazard tracking database.

10. The system of claim 6, wherein the detailed safety analysis phase further comprises performance of software analysis and validation based at least in part on maintenance of the system safety critical functions and the system safety critical events, the software analysis and validation including one or more software criticality analyses leading to software trouble reports.

11. The system of claim 10, wherein the detailed safety analysis phase further comprises an assessment of safety impact based on at least the software trouble reports, ultimately leading to modification of the system hazard tracking database.

12. The system of claim 10, wherein the detailed safety analysis phase further comprises requirements and design changes influencing the one or more software criticality analyses and resulting from requirement changes, design and code changes, and procedure changes themselves resulting from review of the system hazard tracking database.

13. The system of claim 10, wherein the safety disposition phase comprises maintenance of the system hazard tracking database, and maintenance of a software hazard tracking database that is part of the system hazard tracking database.

14. The system of claim 13, wherein the safety disposition phase further comprises generation of operational safety precepts and safety assessment reports resulting from analysis results from the detailed safety analysis phase and reporting from the system hazard tracking database.

15. The system of claim 10, wherein the sustained system safety engineering phase comprises maintenance of the system hazard tracking database, and maintenance of a software hazard tracking database that is part of the system hazard tracking database.

16. The system of claim 15, wherein the sustained system safety engineering phase further comprises assessment of safety impact of software trouble reports, and performance a risk assessment based on the assessment of the safety impact and system safety critical events, the risk assessment leading to updating of the system hazard tracking database.

17. The system of claim 15, wherein the sustained system safety engineering phase further comprises generation of requirement changes, software patches, and procedure changes and training.

18. The system of claim 15, wherein the sustained system safety engineering phase further comprises generation of requirement and design changes, safety device designs, and procedure changes and training based on analysis of and resulting in modification of the system hazard tracking database.

19. A method comprising:
defining a safety program, including a system safety program plan and a preliminary hazard lists based on the system safety program plan;
analyzing the safety program using analysis methods including a preliminary hazard analysis, a system hazard analysis, a subsystem hazard analysis, and an operating and support hazard analysis;
establishing and maintaining a system hazard tracking database based at least in part on the preliminary hazards list, the system hazard tracking database comprising a plurality of records corresponding to defined system safety critical events, system safety critical functions also defined;
dispositioning safety of the system being analyzed, including maintaining the system hazard tracking database, generating operational safety precepts and safety assessment reports resulting from analyzing the system hazard tracking database and presenting the analysis results to various safety review boards; and,
sustaining the safety engineering activities, including maintaining the system hazard tracking database, assessing of a safety impact of software trouble reports, performing a risk assessment based on the assessing of the safety impact and the system safety critical events, and updating the system hazard tracking database based on the risk assessment.

20. The method of claim 19, wherein the system hazard tracking database includes at least a software hazard tracking database.
